(19) United States
(12) Patent Application Publication
(10) Pub. No.: US 2012/0236581 A1
(43) Pub. Date: Sep. 20, 2012

(54) VEHICLE ILLUMINATION SYSTEM AND METHOD THEREOF

(75) Inventor: William E. Stimel, Alexandria, OH (US)

(73) Assignee: CVG MANAGEMENT CORPORATION, New Albany, OH (US)

(21) Appl. No.: 13/420,122

(22) Filed: Mar. 14, 2012

Related U.S. Application Data
(60) Provisional application No. 61/453,265, filed on Mar. 16, 2011.

(51) Int. Cl. B60Q 1/076; B60Q 1/06

(52) U.S. Cl. 362/464; 362/523; 362/526

(57) ABSTRACT

A vehicle illumination system (and method) that facilitates remote adjustment is provided. The system includes an illumination system and an adjustment system. The adjustment system facilitates remote adjustment of an illumination direction and/or at least one illumination characteristic of the illumination system.

### CROSS-REFERENCE TO RELATED APPLICATIONS

This application claims the benefit of U.S. Provisional Patent application Ser. No. 61/453,265 entitled “VEHICLE ILLUMINATION SYSTEM” filed on Mar. 16, 2011. The entireties of the above-noted applications are herein incorporated by reference.

### ORIGIN

The innovation disclosed herein relates to vehicles and more specifically, to headlamps for vehicles whereby the headlamp is remotely adjustable.

### BACKGROUND

A “headlamp” usually refers to a lamp or light, usually attached to the front of a vehicle, for example a car or truck. Headlamps are used to illuminate the road usually during periods of low visibility, such as darkness, inclement weather, etc. While it is not uncommon for the term “headlight” to be used interchangeably in place of a “headlamp,” the term headlamp is technically the correct term for the device itself. The term “headlight” properly refers to a beam of light produced and transmitted by the headlamp device.

Although headlamps are primarily associated with motorized vehicles on the nation's roads and highways, headlamps are often applied to airplanes, trains, construction vehicles and even bicycles. Advancements have been made over the years to increase illumination output, for example, with the introduction of Xenon- and LED-based lighting systems. Additionally, lighting systems have been configured to automatically toggle on and off as appropriate, e.g., at dusk. Unfortunately, today's lighting systems are essentially fixed in position thereby illuminating in a pre-designed direction. Thus, there is a need in the art for a vehicle lighting system that is adaptable and adjustable to meet the desires of an operator.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a vehicle management illumination system (and method) for a vehicle that facilitates remote adjustment is provided. The system includes an illumination system and an adjustment system. The adjustment system facilitates remote adjustment of an illumination direction and/or at least one illumination characteristic of the illumination system.

In accordance with other aspects, the system may include a plurality of sensors disposed on an exterior of the vehicle, and wherein the plurality of sensors detect a direction and/or rotation of a cab of the vehicle, and wherein the adjustment system adjusts the illumination system in response to the detected direction and/or rotation of the cab.

In accordance with still other aspects, the system may include a plurality of sensors disposed on an interior of the vehicle, and wherein the plurality of sensors detect a direction and/or rotation of the operator with respect to a cab of the vehicle, and wherein the adjustment system adjusts the illumination system in response to the detected direction and/or rotation of the operator with respect to the cab.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates an example block diagram of a vehicle illumination management system in accordance with aspects of the innovation.

FIG. 2 illustrates an example block diagram of a vehicle illumination management system in accordance with aspects of the innovation.

FIG. 3 illustrates an example construction cab having a lighting management system installed thereon in accordance with aspects of the innovation.

FIG. 4 illustrates an example construction cab having a lighting management system installed thereon in accordance with aspects of the innovation.

FIG. 5 illustrates a methodology of adjusting an illumination system in accordance with aspects of the innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

While specific characteristics are described herein (e.g., thickness), it is to be understood that the features, functions and benefits of the innovation can employ characteristics that vary from those described herein. These alternatives are to be included within the scope of the innovation and claims appended hereto.

While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

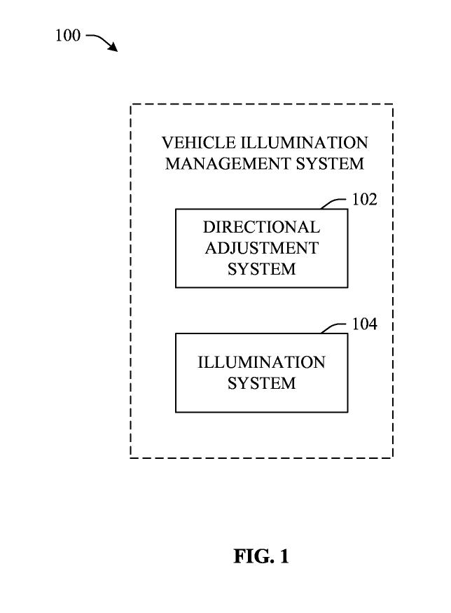

Referring initially to the drawings, FIG. 1 illustrates a vehicle illumination management system 100 in accordance with aspects of the innovation. Essentially, FIG. 1 illustrates an example block diagram of the vehicle illumination management system 100 that includes a directional adjustment system 102 and an illumination system 104. While a directional adjustment system 102 is specifically shown, it is to be understood that other aspects can employ, intensity adjustment (not shown), focal adjustment (not shown), strobe effect, auto-tracking, etc. without departing from the scope of this disclosure. In other words, these features, functions and benefits are to be included within the scope of this disclosure and claims appended hereto.

In operation, the directional adjustment system 102 can be used to, for example, adjust the direction or range of view or illumination by the illumination system 104. The illumination system 104 can include most any illumination source such as, for example, Xenon lights, incandescent lights, LED sources or the like. In operation, the directional adjustment system 102 can be employed to adjust the illumination system 104 as described herein. For example, direction, range of view, focal adjustment, effect(s), etc. can be adjusted via the adjustment system 102.

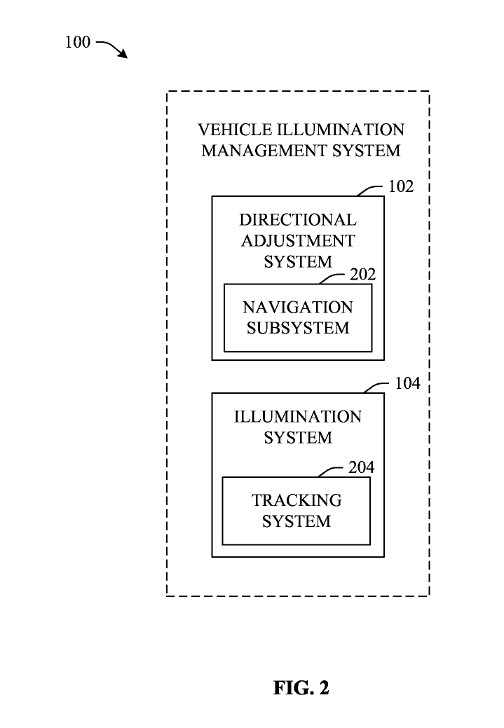

Turning now to FIG. 2, an alternative block diagram of a vehicle illumination system 100 in accordance with aspects of the innovation is shown. As shown, the directional adjustment system 102 can include a navigation subsystem 202 which effects the desired adjustment (e.g., direction, focal, effect, etc.). Specifically, the navigation subsystem 202 provides a means to facilitate the movement of the illumination system 104 to a desired location. For example, the navigation subsystem 202 can include a device or component, such as but not limited to a, selector switch (e.g., right, left, front, rear, etc. selection), a joystick, mouse, touchpad, four-way pad or other navigational system to remotely adjust the illumination system 100.

As shown, the illumination system 104 can include a tracking system 204 that enables adjustment of the illumination system 104. Specifically, the tracking system 204 can track and facilitate a movement and/or an illumination characteristic of the illumination system 104. For example, the tracking system 204 can include sensors, motors, actuators and the like that enable desired adjustment of illumination system components. In yet other aspects, sensors and the like can be applied to an operator's seating device so as to automatically track an operator's field of view thereby auto-adjusting the illumination system to correspond to the field of view.

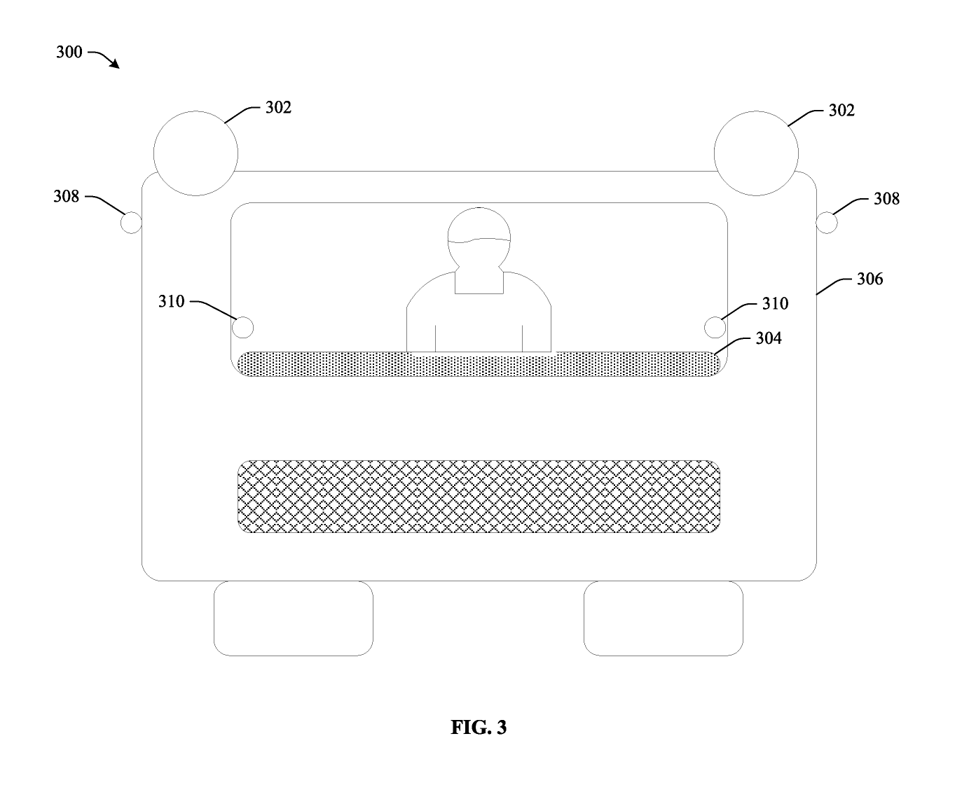

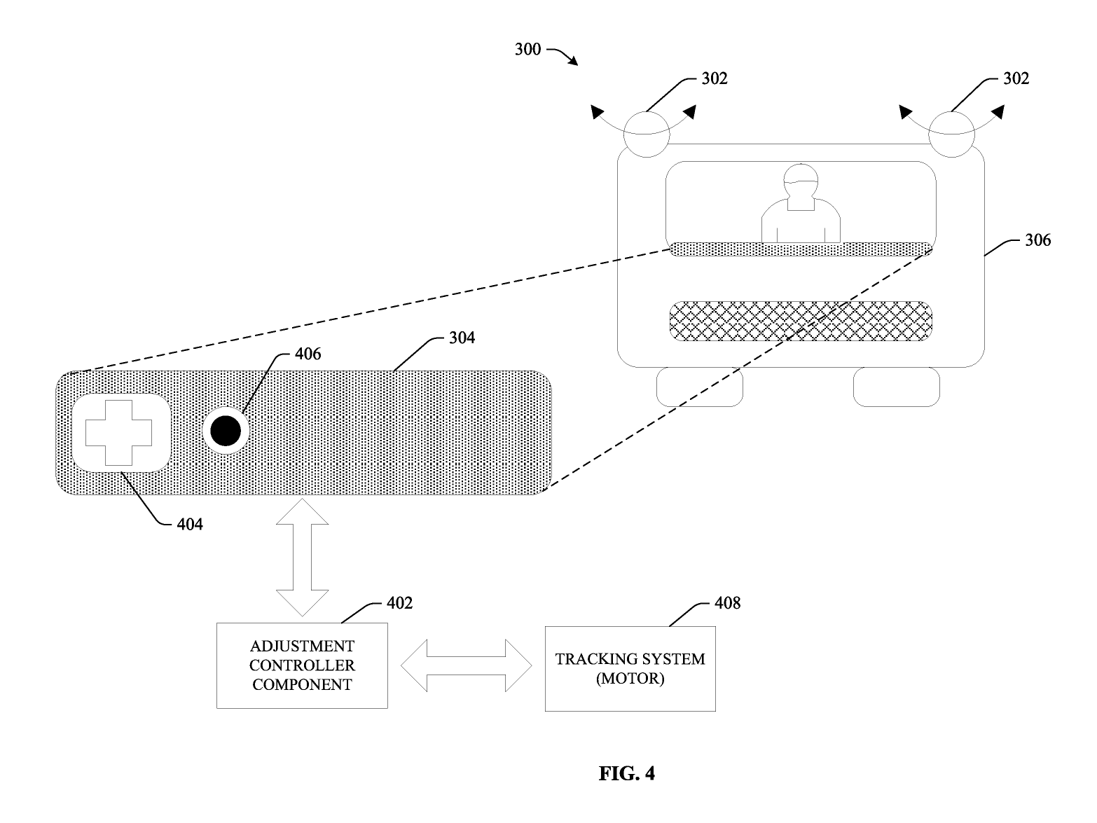

Referring now to FIGS. 3 and 4, FIG. 3 is an illustration of an example embodiment of a vehicle 300 incorporating the vehicle illumination management system 100 described above. The example vehicle 300 illustrated in FIGS. 3 and 4 can be any type of vehicle, such as but not limited to, an automobile, a truck, a bus, a construction vehicle (e.g., backhoe, bulldozer, etc.), a train, an airplane, etc. In the embodiment illustrated in FIGS. 3 and 4, the example vehicle 300 depicts a front view of a construction vehicle. It is to be appreciated that, although a specific orientation and configuration of the construction vehicle 300 is shown, other orientations and configurations exist without departing from the spirit and/or scope of the innovation disclosed and claimed herein. These alternatives are to be included within the scope of this specification.

The vehicle 300 includes a plurality of illumination sources 302 disposed at various locations inside and/or outside the vehicle 300 and a control panel system 304 disposed inside a cab 306. While a specific orientation of the illumination sources 302 is illustrated, it is to be understood that other embodiments can include additional illumination sources, fewer illumination sources as well as illumination sources disposed in alternative locations. These aspects are contemplated and are to be included within the scope of this disclosure herein. The illumination sources 302 can include most any illumination source, such as but not limited to, Xenon lights, incandescent lights, LED

A motor for each illumination source 302 is incorporated into the vehicle illumination management system 100 to move and re-position the illumination sources 302 as desired. The motor(s) can be located at any position in close proximity to each illumination source 302. In an alternative embodiment, the motor(s) can be located inside the illumination source 302. The motor(s) are controlled by signals received from the control panel system 304, which will be described in more detail below. It is to be understood, that the motors can operate in tandem to position the illumination sources 302 together or independently from each other to re-position each illumination source 302. As a result, in an embodiment incorporating a construction vehicle, the illumination sources 302 can be positioned to illuminate the same work area or can be positioned independently of each other to illuminate different work areas.

FIG. 4 is an illustration of an example control panel system 304 in accordance with aspects of the innovation. An operator of the vehicle 300 provides inputs to the control panel system 304, which in turn communicates with an adjustment controller system 402. The adjustment controller system 402 can include a processor, memory or the like to effect efficient and responsive illumination adjustment. Specifically, the adjustment controller system 402 receives signals from the control panel system 304 and can communicate with one or more motors 408 (tracking system 204) to adjust the illumination sources 302 based on inputs from the operator to the control panel system 304.

Still referring to FIG. 4, the control panel system 304 can include input devices, such as but not limited to, touch pads, joy stick, switches, controls, sensors, etc. to effect adjustment of the illumination sources 302 in accordance with aspects of the innovation. In the example embodiment of FIG. 4, a four-way touch pad 404 can be employed to facilitate motion or adjustment of the illumination sources 302. In yet another example embodiment, also shown in FIG. 4, a joy stick 406 can be employed to facilitate motion or adjustment of the illumination sources 302. In alternate embodiments, other means including, but not limited to, touch pads, toggle switches, seating sensors, etc. can be employed so as to effect adjustment of illumination sources 302 in accordance with the innovation. These and other aspects that employ the features, functions and benefits of the innovation are to be included within the spirit and scope of this disclosure.

Referring back to FIG. 3, in alternative embodiments of the innovation, the illumination sources 302 can be automatically adjusted based on inputs from exterior sensors 308 (i.e., sensors located on the outside of the vehicle 300) or interior sensors 310 (i.e., sensors located inside the vehicle 300). For example, exterior sensors 308 can be disposed at any location on an exterior of the vehicle 300 to detect a direction and/or rotation of the cab 306 and adjust the illumination sources 302 accordingly. Further, the interior sensors 310 can be disposed at any location in an interior of the vehicle 300 (i.e., cab 306) to detect a direction of the operator. For example, the interior sensors 310 can be located on an interior wall, the floor, the ceiling, or on a seating apparatus to detect a direction and/or rotation of the operator with respect to the cab 306 and adjust the illumination sources accordingly 302.

Still yet in alternative embodiments, the control panel system 304 can provide controls not only to adjust the direction of the illumination sources 302, but also illumination characteristics of the illumination sources 302. In other words, the control panel system 304 can, based on inputs from the operator, provide controls to adjust illumination characteristics, such as but not limited to, field of view, a focal perspective, intensity, brightness, duration, etc. of the illumination sources 302. These adjustments can be communicated to the adjustment controller component 402, which in turn makes the appropriate adjustments.

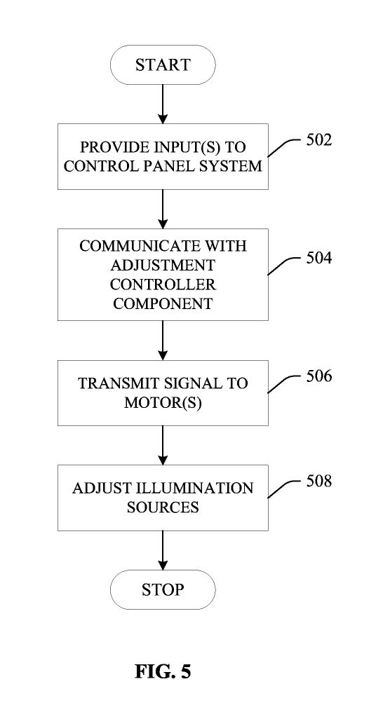

Referring to FIG. 5, a method of adjusting the illumination sources described above will now be described. At 502, the operator provides a desired input or inputs to the control panel system 304. At 504, the control panel system 304 communicates with the adjustment controller component 402. At 506, the adjustment controller component 402 transmits signals to the one or more motors. At 508, the one or more motors adjust the position (or illumination characteristic) of one or more illumination sources 302.

The innovation disclosed and claimed herein, in one aspect thereof, comprises a vehicle illumination management system 100 (and method) that facilitates remote adjustment, for example, of illumination intensity and viewing range of illumination sources. In one aspect, four-way touch pad and/or joystick can be employed to remotely adjust direction of one or more illumination sources. In other aspects, illumination characteristics, such as but not limited to, focal perspective, illumination intensity, effects, etc. can be adjusted as desired. It will be understood that comprehensive adjustment of a vehicle illumination system, for example on a construction cab, can enhance operation, safety and overall experience of an operator and those around the vehicle.

As described above, in yet other aspects, the system can automatically track a direction of an operator thereby providing appropriate lighting corresponding to the operator's direction. In one aspect, exterior sensors can detect a direction and/or rotation of the cab and adjust the illumination sources accordingly. In another aspect, interior sensors (e.g., seat sensors) can be employed to trigger automatic adjustment of the illumination sources to enhance an operator's experience in low-light or low-visibility situations. In this aspect, the lighting system, or portion thereof, can auto track an operator's field of view so as to enhance visibility and overall experience.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle illumination management system comprising:
an illumination system; and
an adjustment system that remotely adjusts at least a subset of the illumination system,
wherein the adjustment system remotely adjusts an illumination direction and/or at least one illumination characteristic of the illumination system.

2. The vehicle illumination management system of claim 1 further comprising an adjustment controller, wherein the adjustment controller receives input signals from the adjustment system and communicates with the illumination system.

3. The vehicle illumination management system of claim 2, wherein the illumination system includes a plurality of illumination sources and a plurality of motors communicating with the plurality of illuminating sources.

4. The vehicle illumination management system of claim 3, wherein the illumination sources are at least one of Xenon, incandescent or LED lighting sources.

5. The vehicle illumination management system of claim 3, wherein the adjustment system includes a control panel system, and wherein an operator provides inputs to the control panel system to adjust the illumination direction and/or illumination characteristics at least one of the plurality of illumination sources.

6. The vehicle illumination management system of claim 5, wherein the illumination characteristics include at least one of one of the field of view, focal perspective, illumination intensity or effect.

7. The vehicle illumination management system of claim 5, wherein the control panel system includes one of a touch pad, joystick or toggle switch to facilitate the operator in providing inputs to the control panel system.

8. The vehicle illumination management system of claim 2, wherein the adjustment system includes a plurality of sensors disposed on an exterior of the vehicle, and wherein the plurality of sensors detect a direction and/or rotation of a cab of the vehicle, and wherein the adjustment system adjusts the illumination system in response to the detected direction and/or rotation of the cab.

9. The vehicle illumination management system of claim 2, wherein the adjustment system includes a plurality of sensors disposed on an interior of the vehicle, and wherein the plurality of sensors detect a direction and/or rotation of the operator with respect to a cab of the vehicle, and wherein the adjustment system adjusts the illumination system in response to the detected direction and/or rotation of the operator with respect to the cab.

10. A vehicle illumination management system comprising:
a plurality of illumination sources;
a tracking system that tracks and facilitates a movement of the plurality of illumination sources; and
a navigation system that remotely effects the adjustment of an illumination direction and/or at least one illumination characteristic of at least one of the plurality of illumination sources.

11. The vehicle illumination management system of claim 10 further comprising an adjustment controller, wherein the adjustment controller receives input signals from the navigation system and communicates with the plurality of illumination sources, and wherein the plurality of illumination sources are at least one of Xenon, incandescent or LED lighting sources.

12. The vehicle illumination management system of claim 11, wherein the tracking system includes a plurality of motors communicating with the plurality of illuminating sources.

13. The vehicle illumination management system of claim 11, wherein the navigation system includes one of a touch pad, joystick or toggle switch, and wherein an operator provides inputs to the navigation system via one of the touch pad, joystick or toggle switch to adjust the illumination direction and/or illumination characteristics of at least one of the plurality of illumination sources.

14. The vehicle illumination management system of claim 13, wherein the illumination characteristics include at least one of one of the field of view, focal perspective, illumination intensity or effect.

15. The vehicle illumination management system of claim 11, wherein the tracking system includes a plurality of sensors disposed on an exterior of the vehicle, and wherein the plurality of sensors detect a direction and/or rotation of a cab of the vehicle, and wherein the tracking system adjusts the illumination sources in response to the detected direction and/or rotation of the cab.

16. The vehicle illumination management system of claim 11, wherein the tracking system includes a plurality of sensors disposed on an interior of the vehicle, and wherein the plurality of sensors detect a direction and/or rotation of the operator with respect to a cab of the vehicle, and wherein the tracking system adjusts the illumination system in response to the detected direction and/or rotation of the operator with respect to the cab.

17. A method of adjusting an illumination system for a vehicle comprising:
providing a plurality of illumination sources;
providing an input to an adjustment system;
transmitting a signal to a tracking system; and
adjusting the illumination system that remotely adjusts at least a subset of the illumination system,
wherein the adjustment system remotely adjusts an illumination direction and/or illumination characteristics of at least one of the plurality of illumination sources.

18. The method of claim 17, wherein prior to transmitting a signal to a tracking system, the method comprising communicating the input from the adjustment system to an adjustment controller component.

19. The method of claim 18, wherein the adjustment system includes a plurality of sensors disposed on an exterior of the vehicle, and wherein the plurality of sensors detect a direction and/or rotation of a cab of the vehicle, and wherein the adjustment system adjusts the illumination system in response to the detected direction and/or rotation of the cab.

20. The method of claim 18, wherein the adjustment system includes a plurality of sensors disposed on an interior of the vehicle, and wherein the plurality of sensors detect a direction and/or rotation of the operator with respect to a cab of the vehicle, and wherein the adjustment system adjusts the illumination system in response to the detected direction and/or rotation of the operator with respect to the cab.
